(19) United States
(12) Patent Application Publication
(10) Pub. No.: US 2026/0235467 A1
(43) Pub. Date: Aug. 13, 2026

(54) METHOD FOR DETECTING A FAULTY MEASUREMENT CHANNEL IN A STRAIN WAVE GEARING MECHANISM

(71) Applicant: Schaeffler Technologies AG & Co. KG, Herzogenaurach (DE)

(72) Inventors: Jens HEIM, Bergrheinfeld (DE); Christoph WEETH, Werneck (DE)

(73) Assignee: Schaeffler Technologies AG & Co. KG, Herzogenaurach (DE)

(21) Appl. No.: 19/471,418

(22) PCT Filed: Mar. 1, 2024
(86) PCT No.: PCT/DE2024/100168

§ 371 Date: Oct. 1, 2025

(30) Foreign Application Priority Data
Apr. 3, 2023 (DE) 10 2023 108 432.1

(51) Int. Cl. G01L 25/00; G01M 13/021

(52) U.S. Cl. CPC G01L 25/006; G01M 13/021

(57) ABSTRACT

A method for detecting a faulty measurement channel on an elastic transmission element in a gearing mechanism, wherein the elastic transmission element has a first strain gauge assembly with multiple first measurement channels. For each measurement channel of the first measurement channels, a plausibility check is carried out using multiple first measurement signals.

### CROSS-REFERENCE TO RELATED APPLICATIONS

This application is the U.S. National Phase of PCT Appln. No. PCT/2024/100168, filed Mar. 1, 2024, which claims the benefit of German Patent Appln. No. 102023108432.1, filed Apr. 3, 2023, the entire disclosures of which are incorporated by reference herein.

### TECHNICAL FIELD

The disclosure relates to a method for detecting a faulty measurement channel on an elastic transmission element in a gearing mechanism, in particular a strain wave gearing mechanism. Furthermore, the disclosure relates to a drive module having a gearing mechanism, in particular a strain wave gearing mechanism.

### BACKGROUND

Strain wave gearing mechanisms (also known as harmonic drives) enable almost play-free power transmission with a high transmission ratio, and are therefore particularly suitable for applications that require precise movements and a small space requirement. Since high torques can be generated with relatively small motors due to the high transmission ratio, strain wave gearing mechanisms can be used to create very compact drive mechanisms that are used, for example, in robotics.

The main components of a strain wave gearing mechanism are a wave generator (“wave generator”), a rigid outer ring (“circular spline”) with an inner toothing and an elastic transmission element (“flexspline”) with an outer toothing arranged therebetween. In contrast to rigid gearing mechanisms, the transmission of torque between the wave generator and the outer ring is based on elastic deformation, in which the transmission ring is deformed into an oval by the wave generator in such a way that it engages with the outer ring on two opposite sides of its circumference. As the wave generator rotates, the transmission ring rolls on the outer ring, such that a torque is transmitted between the transmission ring and the outer ring by means of the intermeshing toothing systems. Thus, the transmission ratio of the gearing mechanism is determined by the difference in the number of teeth on the transmission ring and the outer ring.

During operation, excessive torque, for example when the gearing mechanism is working against high resistance, causes so-called engagement faults. An engagement fault is an at least partial loss of engagement between the transmission ring and the outer ring, such that the teeth of the transmission ring skip over (“ratcheting”) the teeth of the outer ring. While the rotation of the transmission ring and that of the outer ring are strictly coupled during normal operation, such an engagement fault temporarily leads to an uncontrolled relative rotation between the two rings. This creates an unknown angular offset on the output side relative to the drive side, which makes precise checking of the angular position impossible.

Torque sensors in the strain wave gearing mechanism can provide information about the condition of the strain wave gearing mechanism during operation and can be used to monitor its operation. For this purpose, the torque sensors are designed as strain gauges and arranged on the elastic transmission element in order to measure the mechanical stress on the transmission element. The torque acting on the elastic transmission element is then determined from the mechanical stress. Typically, strain gauge assemblies are used with a plurality of strain gauges arranged, for example, in a bridge circuit. If a strain gauge assembly only covers a limited angular range of the transmission element, the measurement signal depends on the angular position of the wave generator. However, if the strain gauge assembly extends over the entire or almost the entire circumference of the transmission element, a measurement signal can be obtained which does not depend, or only depends to a small extent, on the angular position of the wave generator.

In order to detect faulty strain gauges of a strain gauge assembly, WO 2021/148068 A1 discloses a method for checking an assembly of strain gauges which makes it possible to detect a single defect in one of a plurality of strain gauges. The method uses a predictive model determined by finite element analysis or machine learning and therefore requires considerable computing power.

### SUMMARY

Against this background, the object is to provide a method and a system that increases functional safety by identifying a failure or faulty function of a measurement channel of a strain gauge assembly, while reducing the computing power required to detect such a defect.

The object is achieved by a method for detecting a faulty measurement channel on an elastic transmission element in a gearing mechanism, in particular a strain wave gearing mechanism, wherein the elastic transmission element has a first strain gauge assembly having a plurality of first measurement channels, and wherein a plausibility check is carried out for each of the first measurement channels using a plurality of first measurement signals.

The method according to the disclosure makes use of an elastic transmission element comprising a strain gauge assembly. The first strain gauge assembly has a plurality of first measurement channels, each of which provides first measurement signals. By linking these first measurement signals, an output signal can be obtained which is proportional to the torque. This output signal can have a high degree of accuracy and can be used to measure the torque during operation of the transmission element. The method according to the disclosure makes it possible to detect faulty first measurement channels by carrying out a plausibility check for each of the first measurement channels using a plurality of first measurement signals.

A measurement channel of a strain gauge assembly can have one or more strain gauges. The strain gauges measure the mechanical stress in the elastic transmission element, with the mechanical stress being proportional to the present torque. A faulty measurement channel can occur in particular if a strain gauge is damaged. Preferably, each first measurement channel comprises a plurality of strain gauges which are connected in a bridge circuit, in particular a Wheatstone measuring bridge.

The first strain gauge assembly can be arranged on a lateral surface (parallel to the axis of rotation of the transmission element) or an end face (perpendicular to the axis of rotation of the transmission element) of the elastic transmission element. The strain gauges of the plurality of first measurement channels of the first strain gauge assembly are preferably arranged such that two first measurement signals each provide a nearly identical value. The redundancy of the measurement signals can further increase the integrity of the gearing mechanism, in particular strain wave gearing mechanism. The torque is determined from the measurement signals and the measured mechanical stresses, and the determined torque from the first measurement channels depends on the angular position of the wave generator. The first strain gauge assembly may, for example, have two, four or eight measurement channels, the first strain gauge assembly particularly preferably having four measurement channels.

According to a preferred embodiment, the gearing mechanism is designed as a strain wave gearing mechanism, wherein a wave generator acts on the elastic transmission element, the first measurement signals of the individual first measurement channels of the first strain gauge assembly being dependent on the rotational position of the wave generator.

According to an alternative preferred embodiment, the gearing mechanism is designed as a planetary gearing mechanism.

According to a preferred embodiment, for the plausibility check a difference is calculated between a plurality of, in particular two, terms which are dependent on a plurality of first measurement signals. By comparing a plurality of terms, it can be determined whether a measurement channel is faulty. The difference calculation between a plurality of terms is not very computationally intensive and therefore has a particularly positive effect on the required computing power.

The plurality of terms preferably comprises one or more proportionality factors and/or one or more constants, which are preferably determined empirically. A term can be formed from a first measurement signal, a first measurement signal and a proportionality factor, a plurality of first measurement signals, a plurality of first measurement signals with a proportionality factor for the sum of the plurality of first measurement signals or a plurality of first measurement signals with a proportionality factor in each case. Furthermore, it is conceivable for one or more constants to be added to the measurement signal or for one or more constants to be added to the combination of one or more measurement signals with the proportionality factor. These proportionality factors and constants can be determined from experimental data or from simulation data or by calibration. For plausibility checks, the size of the difference can be calculated and compared with a tolerance value. This tolerance value can be determined empirically or by simulation, and the tolerance value can be selected identically for all measurement channels or can be determined individually for each measurement channel. Furthermore, the tolerance value can have a fixed value or be adjusted as the operating period progresses.

According to a preferred embodiment, the elastic transmission element has a second strain gauge assembly having a second measurement channel, wherein a second measurement signal of the second measurement channel of the second strain gauge assembly is proportional to the torque and does not depend, or depends only to a small extent, on an angular position of the wave generator, and the plausibility check is carried out for each of the first measurement channels using one or more first measurement signals and/or the second measurement signal. The second strain gauge assembly has a second measurement channel, the second measurement signal of which does not depend, or only depends to a small extent, on the angular position of the wave generator. The second strain gauge assembly can extend around the entire or almost the entire circumference of the elastic transmission element. The second strain gauge assembly can be arranged on a lateral surface (parallel to the axis of rotation of the transmission element) or an end face (perpendicular to the axis of rotation of the transmission element) of the elastic transmission element.

Preferably, the first and second strain gauge assemblies are arranged together on the lateral surface or together on the end face. Particularly preferably, the second measurement channel comprises a plurality of strain gauges which are connected in a bridge circuit, in particular a Wheatstone measuring bridge.

Advantageously, the integrity of the torque measurement can be further increased by a plausibility check with a second measurement channel. It is conceivable for the plausibility check of the first measurement channels to be carried out via one or more first measurement signals in optional combination with the second measurement signal. For example, the second measurement signal can be taken into account for selected first measurement channels when checking the plausibility of the selected first measurement channel and not for other first measurement channels.

According to a preferred embodiment, a plausibility check is carried out for the second measurement channel using a plurality of first measurement signals. The plausibility of the second measurement signal can be checked using a plurality of first measurement signals. Checking the second measurement signal increases the integrity of the measured torque value. The second strain gauge assembly may not depend, or may depend only to a small extent, on the angular position of the wave generator, and this advantageously enables a torque value which does not require any further calculation step. However, such a torque value may have some residual ripple.

According to a preferred embodiment, for the plausibility check, a difference is calculated between a first term dependent on one or more first measurement signals and a second term dependent on the second measurement signal. It is therefore possible to identify whether a measurement channel is faulty by comparing the first term and the second term. This simple calculation has a particularly beneficial effect on the required computing power.

The embodiments and technical effects explained above regarding the formation of terms and calculation of differences also apply analogously to the first and second terms.

The disclosure also relates to a method for determining a torque acting on an elastic transmission element of a gearing mechanism, in particular a strain wave gearing mechanism, wherein a faulty first or, if applicable, second measurement channel is detected according to a method according to any one of the preceding embodiments, the faulty measurement channel is corrected using one or more first measurement signals and wherein the torque acting on the transmission element is determined using the corrected measurement channel and/or the remaining measurement channels.

The detection, according to the disclosure, of a faulty first or, if applicable, second measurement channel makes it possible to correct the first or, if applicable, second measurement channel identified as faulty. To correct the faulty first or, if applicable, second measurement channel, a substitute signal can be determined which is dependent on one or more first measurement signals. In addition, the corrected first or, if applicable, second measurement channel can be included in the determination of the torque acting on the transmission element. The correction of a faulty measurement channel can either mean exchanging the measurement signal of a faulty measurement channel with a measurement signal of a non-faulty measurement channel or determining the measurement signal present on the faulty measurement channel via a weighted or non-weighted summation of a plurality of measurement signals from non-faulty measurement channels. During summation, it is also conceivable for one or more constant(s) to be added, with the constant or constants being predefined according to the faulty measurement channel.

The advantage is that a faulty channel can be corrected or replaced so that this channel further increases the integrity of the measured torque on the strain wave gearing mechanism.

Preferably, only exactly one first measurement signal and one second measurement signal are required to correct the measurement channel identified as faulty. This does not require a computationally intensive prediction model. Preferably, a first measurement signal and the second measurement signal are each multiplied by a proportionality factor and/or a constant is added thereto.

Preferably, with a corrected second measurement signal, no further measurement channel is required to determine the torque acting on the transmission element. This also has a particularly positive effect on the required computing power, and this results in a reduced quality of the torque output signal.

The disclosure also relates to a drive module having a gearing mechanism, in particular a strain wave gearing mechanism, and having an evaluation unit which is configured to detect a faulty first or, if applicable, second measurement channel according to a method according to any one of the aforesaid embodiments, to correct the faulty measurement channel using one or more first measurement signals and to determine the torque acting on the transmission element using the corrected measurement channel and/or one or more remaining measurement channels.

The drive module can achieve the same advantages and effects that have already been described in connection with the method according to the disclosure for detecting a faulty measurement channel.

The disclosure further relates to a robot arm having at least one drivable arm segment, wherein the arm segment can be driven via the drive module according to one of the preceding embodiments of the disclosure.

The robot arm can achieve the same advantages and effects that have already been described in connection with the method according to the disclosure for detecting a faulty measurement channel. The advantageous embodiments and features described in connection with the method according to the disclosure for detecting a faulty measurement channel can also be applied to the robot arm, alone or in combination.

### BRIEF DESCRIPTION OF THE DRAWINGS

Further details and advantages of the disclosure are explained below with reference to the exemplary embodiment shown in the drawings. In the drawings:

FIG. 1 shows an exemplary embodiment of an elastic transmission element with a first and a second strain gauge assembly;

FIG. 2 shows a schematic representation of a preferred circuitry of strain gauges of a measurement channel;

FIG. 3 shows a plurality of measurement signals from different first measurement channels of an exemplary embodiment of the method according to the disclosure;

FIG. 4 shows a schematic flowchart of an exemplary embodiment of the method according to the disclosure;

FIG. 5 shows an exemplary embodiment of a robot in a schematic representation.

### DETAILED DESCRIPTION

FIG. 1 shows an elastic transmission element 1, wherein the elastic transmission element 1 has a second strain gauge assembly 10 and a first strain gauge assembly 20. The elastic transmission element 1 can be used as part of a gearing mechanism designed as a strain wave gearing mechanism. Alternatively, the elastic transmission element 1 can also be used in a planetary gearing mechanism. The strain wave gearing mechanism can have a wave generator, a rigid outer ring having an internal toothing system and the elastic transmission element 1 arranged therebetween.

In the exemplary embodiment, the two strain gauge assemblies are arranged on an end face of the transmission element 1, which is arranged perpendicular to an axis of rotation of the transmission element 1. The second strain gauge assembly 10 extends completely over the circumference of the transmission element 1, i.e. it completely covers the angular range around the axis of rotation. The first strain gauge assembly 20 comprises a plurality of, here four, first measurement channels 22, 23, 24, 25. In the exemplary embodiment, the first strain gauge assembly 20 is arranged radially outside the second strain gauge assembly 10. According to a modification of this exemplary embodiment, the first strain gauge assembly 20 can be arranged radially inside the second strain gauge assembly 10.

The second measurement channel and the first measurement channels 22, 23, 24, 25 each have a plurality of strain gauges. As a result of mechanical load, the strain gauges are deformed and their electrical resistance changes. This change in resistance can be detected and from this the mechanical stress in the elastic transmission element 1 and the torque acting on the transmission element 1 can be derived.

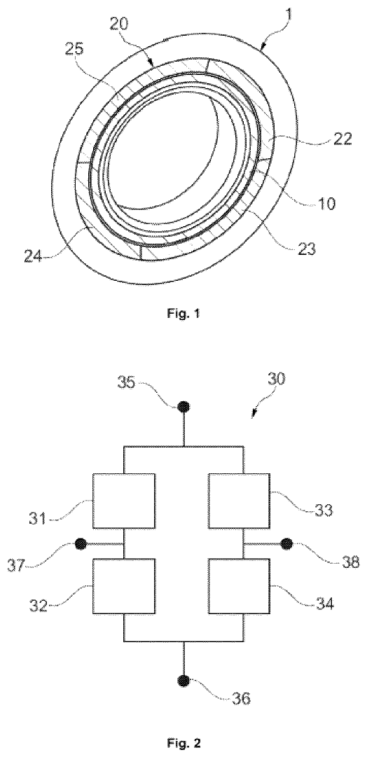

FIG. 2 shows an exemplary schematic representation of a preferred circuitry 30 of the strain gauges of a measurement channel as a Wheatstone bridge. This circuitry is preferably used for the second measurement channel and the first measurement channels 22, 23, 24, 25.

The bridge circuit shown in FIG. 2 comprises four strain gauges 31, 32, 33, 34. Two of these strain gauges 31, 32, 33, 34 are each connected in series to form one branch of the bridge circuit. The bridge circuit comprises two branches connected in parallel. A supply voltage is applied to the branches between a supply voltage terminal 35 and a ground terminal 36. A tap 37, 38 is provided between the two strain gauges of each branch and is used to tap the measurement signal of the measurement channel.

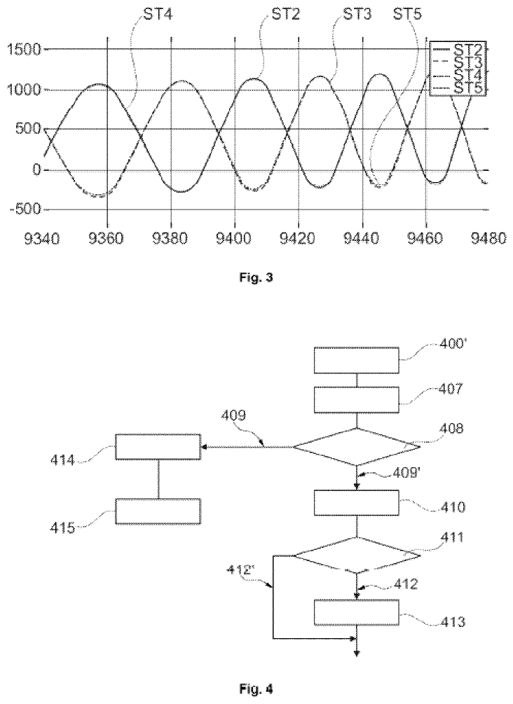

FIG. 3 shows first measurement signals ST2, ST3, ST4, ST5 of the first measurement channels of an exemplary embodiment. In this exemplary embodiment, the first measurement channels are provided on the elastic transmission element 1 in such a way that two first measurement channels each deliver a nearly identical measurement signal. In this case, the measurement signals ST2 and ST4 are almost identical and the measurement signals ST3 and ST5.

The sum of all four first measurement signals ST2, ST3, ST4, ST5 is proportional to the torque present at the elastic transmission element 1. The torque can be calculated by multiplying the sum of all four first measurement signals ST2, ST3, ST4, ST5 by a predetermined proportionality factor C2:

$$T 2 = ( ST 2 + ST 3 ST 4 + ST 5 ) * C 2$$

The second measurement channel with its second measurement signal ST1 can also provide a measure for the torque with proportionality factor C1:

$$T 1 = ST 1 * C 1$$

Further torque values T3, T4, T5, T6 can be determined, each of which depends on only three first measurement signals:

$$T 3 = ( 2 * ST 2 + ST 3 + ST 5 ) * C 3$$

$$T 4 = ( ST 2 + 2 * ST 3 + ST 4 ) * C 4$$

$$T 5 = ( ST 3 + 2 * ST 4 + ST 5 ) * C 5$$

$$T 6 = ( ST 2 + ST 4 + 2 * ST 5 ) * C 6$$

The values C3 to C6 are predetermined proportionality factors. The torque values T3, T4, T5, T6 shown above each describe calculation options for the torque, with one of the overall four first measurement signals ST2, ST3, ST4 or ST5 not being included. Instead of the first non-included measurement signal ST2, ST3, ST4, ST5, one of the other first measurement signals ST2, ST3, ST4, ST5 is included with double weighting.

In an alternative preferred embodiment, each measurement signal ST1, ST2, ST3, ST4, ST5 can have its own proportionality factor and/or a constant.

Thus, the torque values are determined, for example, as follows:

$$T 3 = ( 2 * ST 2 * C 32 + ST 3 * C 33 + ST 5 * C 35 ) * C 3 \qquad a .$$

For the proportionality factors according to the format Cxy, x describes the index for the torque value Tx to be determined and y the index for the measurement signal STy to be weighted.

FIG. 4 shows a flowchart of an exemplary embodiment of the method 400′ according to the disclosure.

In test step 407, the following plausibility signals PS1 to PS7 are formed:

$$PS 1 = abs ( ST 2 - ST 4 )$$

$$PS 2 = abs ( ST 3 - ST 5 )$$

$$PS 3 = abs ( ( 2 \cdot ST 2 + ST 3 + ST 5 ) \cdot c\_ 3 - ST 1 \cdot c\_ 1 ) = abs ( T\_ 3 - T\_ 1 )$$

$$PS 4 = abs ( ( ST 2 + 2 \cdot ST 3 + ST 4 ) \cdot c\_ 4 - ST 1 \cdot c\_ 1 ) = abs ( T\_ 4 - T\_ 1 )$$

$$PS 5 = abs ( ( ST 3 + 2 \cdot ST 4 + ST 5 ) \cdot c\_ 5 - ST 1 \cdot c\_ 1 ) = abs ( T\_ 5 - T\_ 1 )$$

$$PS 6 = abs ( ( ST 2 + ST 4 + 2 \cdot ST 5 ) \cdot c\_ 6 - ST 1 \cdot c\_ 1 ) = abs ( T\_ 6 - T\_ 1 )$$

$$PS 7 = ( ( ST 2 + ST 3 + ST 4 + ST 5 ) \cdot c\_ 2 - ST 1 \cdot c\_ 1 ) = abs ( T\_ 2 - T\_ 1 )$$

Alternatively or additionally, the plausibility signals PS8 to PS17 listed below can be formed, by means of which a plausibility check is only possible on the basis of the first measurement signals ST2, ST3, ST4, ST5, which are included in the terms T2 to T6.

$$PS 8 = abs ( T\_ 3 - T\_ 2 )$$

$$PS 9 = abs ( T\_ 4 - T\_ 2 )$$

$$PS 10 = abs ( T\_ 5 - T\_ 2 )$$

$$PS 11 = abs ( T\_ 6 - T\_ 2 )$$

$$PS 12 = abs ( T\_ 4 - T\_ 3 )$$

$$PS 13 = abs ( T\_ 5 - T\_ 3 )$$

$$PS 14 = abs ( T\_ 6 - T\_ 3 )$$

$$PS 15 = abs ( T\_ 5 - T\_ 4 )$$

$$PS 16 = abs ( T\_ 6 - T\_ 4 )$$

$$PS 17 = abs ( T\_ 6 - T\_ 5 )$$

The plausibility signals are compared with predetermined tolerance values LV1 to LV7. The factors c_1-6 represent proportionality factors, which are preferably determined and defined empirically before the strain wave gearing mechanism unit is put into operation for the first time.

The plausibility signals therefore represent only simple differences between the measurement signals, which require very little computing power. On the one hand, for the plausibility check, a difference can be calculated between a plurality of, in particular two, terms that depend on the plurality of first measurement signals; cf. PS1, PS2 and PS8 to PS17. On the other hand, for plausibility checks, a difference can be calculated between a first term dependent on one or more first measurement signals ST2, ST3, ST4, ST5 and a second term dependent on the second measurement signal ST1; cf. PS3 to PS7.

These differences can be compared with tolerance values and allow a statement to be made about the faultiness of a measurement channel in predefined conditional equations.

In order to determine which of the signals is faulty, the following conditional equations are checked:
1. (PS1>LV1)∩(PS3>LV3),→the measurement signal ST2 of the measurement channel 22 is faulty.
2. (PS1>LV1)∩(PS5>LV5),→the measurement signal ST3 of the measurement channel 23 is faulty.
3. (PS2>LV2)∩(PS4>LV4),→the measurement signal ST4 of the measurement channel 24 is faulty.
4. (PS2>LV2)∩(PS6>LV6),→the measurement signal ST5 of the measurement channel 25 is faulty.
5. (PS7>LV7)∩(PS1≤LV1)∩(PS2≤LV2),→the measurement signal ST1 of the second measurement channel is faulty.

This allows a faulty first or, if applicable, second measurement channel to be clearly detected.

Measurement signals from faulty measurement channels can be corrected as follows:
Faulty ST2: The measurement signal ST2 is replaced by the measurement signal of ST4.
Faulty ST4: The measurement signal ST4 is replaced by the measurement signal of ST2.
Faulty ST3: The measurement signal ST3 is replaced by the measurement signal of ST5.
Faulty ST5: The measurement signal ST5 is replaced by the measurement signal of ST3.
Faulty ST1: The measurement signal ST1 is replaced by the following formula:

$$ST 1 = ( ST 2 + ST 3 + ST 4 + ST 5 ) \cdot c\_ 2 / c\_ 1 ,$$

where c_1 and c_2 represent proportionality factors, which were preferably determined empirically before the strain wave gearing mechanism was first put into operation. First, in a method step 408, it is checked whether all the first measurement channels 22, 23, 24, 25 are faulty. If this is the case (arrow 409), a state 414 with four defective first measurement channels 22, 23, 24, 25 is present. In a notification step 415, an error message is generated and, if necessary, transmitted to the motor control unit. Error correction is not possible.

Unless all of the first measurement channels 22, 23, 24, 25 are defective (arrow 409′), error registers are set for the respective defective measurement channels 22, 23, 24, 25 in step 410. Subsequently, in step 411, it is checked whether only a single first measurement channel 22, 23, 24, 25 is defective. If there is such a single error of a first measurement channel 22, 23, 24, 25 (arrow 412), the faulty first measurement channel 22, 23, 24, 25 is corrected. The faulty measurement signal ST2, ST3, ST4, ST5 is corrected in step 413 and, after the correction, the strain wave gearing mechanism can continue to operate normally. If there is no faulty measurement signal, operation of the strain wave gearing mechanism continues normally (arrow 412).

In an alternative preferred embodiment, in the above-described exemplary embodiment, the second measurement channel is checked in parallel with the checking of the first measurement channels 22, 23, 24, 25. If the first measurement channels 22, 23, 24, 25 are not faulty and only the second measurement channel has a defect, the second measurement signal ST1 can be replaced or determined or corrected by one or more first measurement signals ST2, ST3, ST4, ST5.

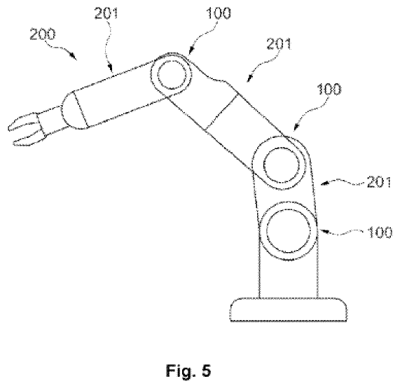

FIG. 5 shows, in a schematic representation, an exemplary embodiment of a robot designed as an industrial robot 200 with a plurality of arm segments 201, each rotatably connected via drive modules 100, with which the disclosure is implemented. Even though the industrial robot 200 shown here has three arm segments 201 and three drive modules 100, embodiments of the industrial robot 200 are conceivable with a different number of arm segments 201 and drive modules 100, for example four, five, six or seven. Furthermore, a drive module 100 can be used for any robot joints. Such industrial robots 200 are often used as collaborative robots that work in close cooperation with humans.

1. A method for detecting a faulty measurement channel on an elastic transmission element in a gearing mechanism, the method comprising:
providing the elastic transmission element having first strain gauge assembly having a plurality of first measurement channels, performing a plausibility check for each of the first measurement channels using a plurality of first measurement signals.

2. The method according to claim 1, wherein the gearing mechanism is configured as a strain wave gearing mechanism,
wherein a wave generator acts on the elastic transmission element,
wherein the first measurement signals of the individual first measurement channels of the first strain gauge assembly are dependent on a rotational position of the wave generator.

3. The method according to claim 1, wherein for the plausibility check a difference is calculated between a plurality of terms which are dependent on the plurality of first measurement signals.

4. The method according to claim 2, wherein the elastic transmission element has a second strain gauge assembly having a second measurement channel, wherein a second measurement signal of the second measurement channel of the second strain gauge assembly is proportional to a torque and does not depend, or depends only to a small extent, on an angular position of the wave generator, wherein for each of the first measurement channels the plausibility check is carried out using at least one of the first measurement signals or the second measurement signal.

5. The method according to claim 4, wherein a plausibility check is carried out for the second measurement channel using the plurality of first measurement signals.

6. The method according to claim 4, wherein, for the plausibility check, a difference is calculated between a first term dependent on one or more first measurement signals and a second term dependent on the second measurement signal.

7. The method for according to claim 1, wherein, when a faulty first measurement channel is detected, the faulty measurement channel is corrected using one or more first measurement signals and
wherein a torque acting on the transmission element is determined using at least one of the corrected measurement channel or the remaining measurement channels.

8. A drive module comprising:
a gearing mechanism having an elastic transmission element, and
an evaluation unit having a first strain gauge assembly having a plurality of first measurement channels,
wherein the evaluation unit is configured to;
detect a faulty first or, if applicable, second measurement channel by performing a plausibility check for each of the first measurement channels using a plurality of first measurement signals,
correct the faulty measurement channel using one or more first measurement signals and determine a torque acting on the transmission element using at least one of the corrected measurement channel or one or more remaining measurement channels.

9. A robot arm having at least one drivable arm segment, wherein the arm segment is drivable via the drive module according to claim 8.

10. The drive module according to claim 8, wherein the gearing mechanism is configured as a strain wave gearing mechanism, wherein a wave generator acts on the elastic transmission element, and wherein the first measurement signals of the individual first measurement channels of the first strain gauge assembly are dependent on a rotational position of the wave generator.

11. The drive module according to claim 8, wherein for the plausibility check a difference is calculated between a plurality of terms which are dependent on the plurality of first measurement signals.

12. The drive module according to claim 10, wherein the elastic transmission element has a second strain gauge assembly having a second measurement channel, wherein a second measurement signal of the second measurement channel of the second strain gauge assembly is proportional to a torque and does not depend, or depends only to a small extent, on an angular position of the wave generator, wherein for each of the first measurement channels the plausibility check is carried out using at least one of the first measurement signals or the second measurement signal.

13. The drive module according to claim 12, wherein a plausibility check is carried out for the second measurement channel using the plurality of first measurement signals.

14. The drive module according to claim 12, wherein, for the plausibility check, a difference is calculated between a first term dependent on one or more first measurement signals and a second term dependent on the second measurement signal.
